(19) United States
(12) Patent Application Publication
(10) Pub. No.: US 2016/0321226 A1
(43) Pub. Date: Nov. 3, 2016

(54) INSERTION OF UNSAVED CONTENT VIA CONTENT CHANNEL

(71) Applicant: MICROSOFT TECHNOLOGY LICENSING, LLC, Redmond, WA (US)

(72) Inventors: Michelle Keslin, Kirkland, WA (US); Peter Sommer, Carnation, WA (US); Ali Taleghani, Redmond, WA (US); Jitesh Sachdeva, Bellevue, WA (US)

(21) Appl. No.: 14/842,647

(22) Filed: Sep. 1, 2015

Related U.S. Application Data
(60) Provisional application No. 62/155,716, filed on May 1, 2015.

(51) Int. Cl. G06F 17/24; G06F 17/21

(52) U.S. Cl. CPC G06F 17/24; G06F 17/211

(57) ABSTRACT

Insertion of unsaved content through a content channel is provided. A productivity service receives a content change of a document from a productivity application through a content channel within a period of time. The period of time is within a range of a real time. The content change is applied into the document managed by the productivity service. Subsequently, the content change is transmitted to another productivity application through another content channel within another period of time. The content change is transmitted to prompt the other productivity application to present the document with the content change. The other period of time is also within the range of the real time.

### CROSS-REFERENCE TO RELATED APPLICATION

This Application claims the benefit under 35 U.S.C. §119(e) of U.S. Provisional Patent Application Ser. No. 62/155,716 filed on May 1, 2015. The disclosure of the U.S. Provisional Patent Application is hereby incorporated by reference in its entirety.

### BACKGROUND

People interact with computer applications through user interfaces. While audio, tactile, and similar forms of user interfaces are available, visual user interfaces through a display device are the most common form of a user interface. With the development of faster and smaller electronics for computing devices, smaller size devices such as handheld computers, smart phones, tablet devices, and comparable devices have become common. Such devices execute a wide variety of applications ranging from communication applications to complicated analysis tools. Many such applications present documents. Collaboration applications may present a document for co-authoring. Complex schemes may be necessary to maintain a synchronous document in co-authoring environments.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to an insertion of unsaved content through a content channel. In some examples, a productivity service may receive a content change associated with a document from a productivity application through a content channel. The document may be presented by the productivity application. The content change may be received within a range of a real time. Subsequently, the content change may be applied to the document. The content change may also be transmitted to another productivity application through another content channel within another period of time. The content change may be transmitted to prompt the other productivity application to present the document with the content change. The other period of time may be within the range of the real time.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a conceptual diagram illustrating an example of inserting unsaved content through a content channel, according to embodiments;

FIG. 2 is a display diagram illustrating an example scenario of an insertion of unsaved content into a document through a content channel, according to embodiments;

FIG. 3 is a display diagram illustrating another example of an insertion of unsaved content into a document through a content channel, according to embodiments;

FIG. 4 is a display diagram illustrating an example scenario of an insertion of unsaved content into a document through a content channel that provides a peer-to-peer service, according to embodiments;

FIG. 5 is a simplified networked environment, where a system according to embodiments may be implemented;

FIG. 6 is a block diagram of an example computing device, which may be used to insert unsaved content through a content channel; and

FIG. 7 is a logic flow diagram illustrating a process for insertion of unsaved content through a content channel, according to embodiments.

### DETAILED DESCRIPTION

Under present systems, the coauthoring of documents is generally accomplished by having each user save changes to a document. That is, the entire document must be saved (e.g., to a server) in order to commit any changes made by a coauthor and send them to the other coauthors for synchronization and display. Such techniques have significant performance limitations, in both the time and data required to synchronize a coauthored document.

To overcome these and other limitations, the present techniques provide transmission of unsaved content through a content channel separate from that through which saved content is transmitted. That is, in between save operations, unsaved content is transmitted through this separate channel in smaller, instantaneous or near instantaneous chunks. Unsaved content is thus viewable by coauthors in a real time or near real time manner, enhancing the coauthoring environment. When a save operation occurs, unsaved content since the last save operation is resolved for any conflicts and then committed to the document.

As briefly described above, an insertion of an unsaved content through a content channel may be provided by a productivity service. The productivity service may receive a content change associated with a document from a productivity application through a content channel within a period of time. The productivity service may host the document. The productivity application may present the document.

The period of time to transmit the content change through the content channel may be within a range of a real time. The content change may include an edit operation, an insertion operation, and/or a deletion operation, among similar operations applied to a text, a paragraph, a format attribute, a table, a list, an image, and/or an attachment, among other components of the document.

The content channel may include a pipeline created to connect the productivity application and the productivity service to establish real time communications. The real time communications may be established by constructing the content channel using a direct route with a low number of intermediary connections that achieves a low latency connection.

The productivity service may apply the content change to the document. Furthermore, the content change may be transmitted to another productivity application through another content channel within another period of time. The content change is transmitted to prompt the other productivity application to present the document with the content change. The other period of time may also be within the range of the real time.

In the following detailed description, references are made to the accompanying drawings that form a part hereof, and in which are shown by way of illustrations, specific embodiments, or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a physical computer-readable memory device. The computer-readable storage medium can for example be implemented via one or more of a volatile computer memory, a non-volatile memory, a hard drive, a flash drive, a floppy disk, or a compact disk, and comparable hardware media.

Throughout this specification, the term “platform” may be a combination of software and hardware components to insert unsaved content through a content channel. Examples of platforms include, but are not limited to, a hosted service executed over a plurality of servers, an application executed on a single computing device, and comparable systems. The term “server” generally refers to a computing device executing one or more software programs typically in a networked environment. More detail on these technologies and example operations is provided below.

A computing device, as used herein, refers to a device comprising at least a memory and a processor that includes a desktop computer, a laptop computer, a tablet computer, a smart phone, a vehicle mount computer, or a wearable computer. A memory may be a removable or non-removable component of a computing device configured to store one or more instructions to be executed by one or more processors. A processor may be a component of a computing device coupled to a memory and configured to execute programs in conjunction with instructions stored by the memory. A file is any form of structured data that is associated with audio, video, or similar content. An operating system is a system configured to manage hardware and software components of a computing device that provides common services and applications. An integrated module is a component of an application or service that is integrated within the application or service such that the application or service is configured to execute the component. A computer-readable memory device is a physical computer-readable storage medium implemented via one or more of a volatile computer memory, a non-volatile memory, a hard drive, a flash drive, a floppy disk, or a compact disk, and comparable hardware media that includes instructions thereon to automatically save content to a location. A user experience—a visual display associated with an application or service through which a user interacts with the application or service. A user action refers to an interaction between a user and a user experience of an application or a user experience provided by a service that includes one of touch input, gesture input, voice command, eye tracking, gyroscopic input, pen input, mouse input, and keyboards input. An application programming interface (API) may be a set of routines, protocols, and tools for an application or service that enable the application or service to interact or communicate with one or more other applications and services managed by separate entities.

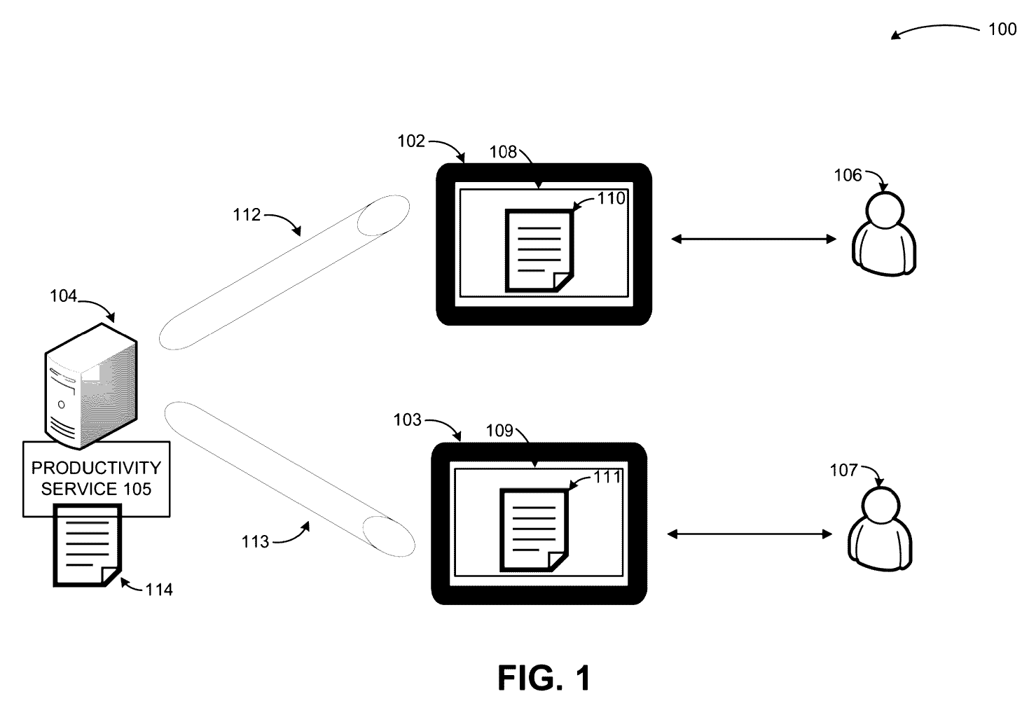

FIG. 1 is a conceptual diagram illustrating an example of inserting unsaved content through a content channel, according to embodiments.

In a diagram 100, a physical server 104 may execute a productivity service 105. The productivity service 105 may provide content such as a document 114 to computing devices that consume the content. An example scenario may include a collaboration environment where computing devices present the document 114 hosted by the physical server 104. The physical server 104 may be a hardware device that provides services to client devices.

A computing device 102 may execute a productivity application 108 that displays an instance 110 of the document 114 provided by the productivity service 105. Examples of the productivity application 108 may include a document processing application, a spreadsheet processing application, and/or a presentation application, among others. Example of the instance 110 may include a section (such as a paragraph, and/or a page, among others) of the document 114 displayed by the productivity application 108. A computing device 103 may execute another productivity application 109 that presents an instance 111 of the document 114 provided by the productivity service 105. Example of the other productivity application 109 may include a web browser, among others.

The computing devices (102 and 103) may include a tablet device, a laptop computer, a desktop computer, and/or a smart phone, among others. The computing devices (102 and 103) may display the productivity applications (108 and 109) to users (106 and 107), respectively.

The users (106 and 107) may collaborate in co-authoring the document 114 hosted by the physical server 104 through the instance 110 and the instance 11. The users (106 and 107) may be allowed to interact with the productivity applications (108 and 109), respectively, through an input device or touch enabled display component of the computing devices (102 and 103). The computing devices (102 and 103) may include display devices such as the touch enabled display component, and a monitor, among others to provide the productivity applications (108 and 109) to the users (106 and 107), respectively.

The users (106 and 107) may interact with the productivity applications (108 and 109), respectively, with a keyboard based input, a mouse based input, a voice based input, a pen based input, and/or a gesture based input, among others. The gesture based input may include touch based actions such as a touch action, a swipe action, and/or a combination of each, among others.

The productivity service 105 of the physical server 104 may receive a content change associated with the document 114 transmitted through a content channel 112. The content channel 112 may be a pipeline constructed to provide real time communications between the productivity application 108 and the productivity service 105 of the physical server 104.

The content change may be applied to the document 114 to synchronize the instance 110 with the document 114 managed by the physical server 104. The content change may also be transmitted to the other productivity application 109 to prompt the other productivity application 109 to display the document 114 with the content change as the instance 111.

The physical server 104 may include a web server, and/or a document server, among others. The computing devices (102 and 103) may communicate with the physical server 104 through a network. The network may provide wired or wireless communications between nodes such as the physical server 104, the computing device 102, or the computing device 103, among others.

While the example system in FIG. 1 has been described with specific components including the computing devices (102 and 103), the physical server 104, the productivity applications (108 and 109), and the productivity service 105, embodiments are not limited to these components or system configurations and can be implemented with other system configurations employing fewer or additional components.

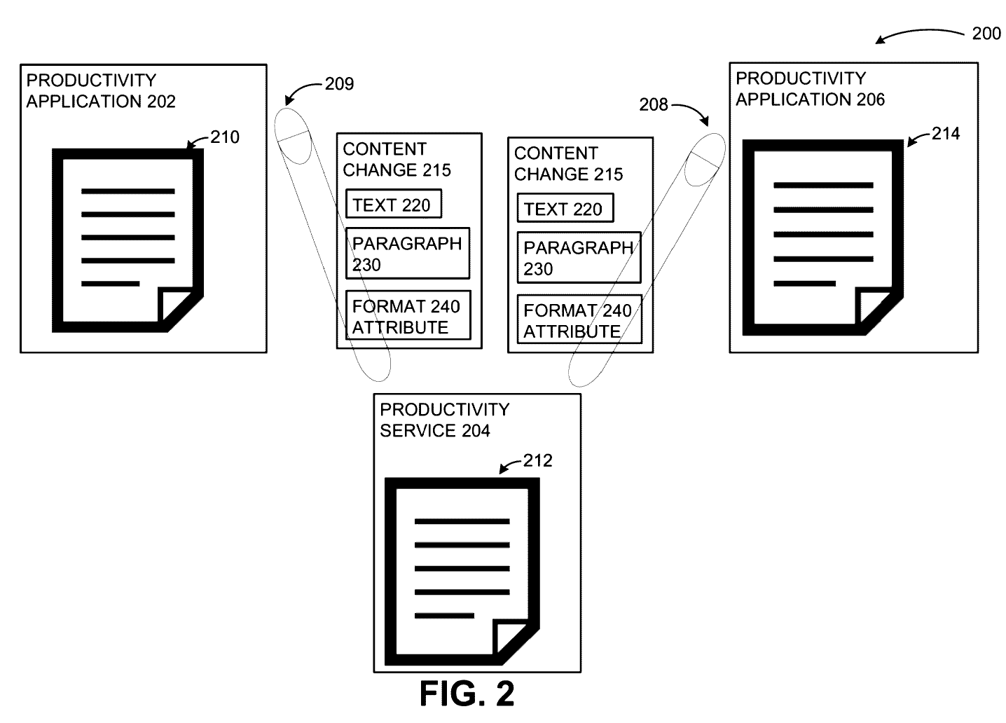

FIG. 2 is a diagram illustrating an example scenario of an insertion of unsaved content into a document through a content channel, according to embodiments.

In a diagram 200, a productivity service 204 may manage synchronization of a content change 215 detected on an instance 210 of a document 212 in real time. The content change 215 may include a text 220, a paragraph 230, and/or a format attribute 240, among others that may be applied to the instance 210 of the document 212 through an edit operation, an insertion operation, or a deletion operation.

The instance 210 of the document 212 may include a section of the document 212 displayed by the productivity application 202. For example, the section may include a page, and/or a paragraph, among other sections of the document 212. Another instance 214 of the document 212 may also be presented by the productivity application 206.

The productivity service 204 may attempt to synchronize the content change 215 (applied to the instance 210) to the document 212 in real time. The productivity service 204 may also transmit the content change 215 to the productivity application 206 so that the instance 214 of the document 212 may be presented with the content change 215 in real time. As such, a detected change to the document 212 may be displayed in real time on an alternate platform, such as the productivity application 206.

The content change 215 may be synchronized to the document when the productivity service receives the content change 215 through a content channel 209. The content channel 209 may establish real time communication between the productivity application 202 and the productivity service 204. The content channel 209 may be constructed with a scheme to minimize a number of intermediary connections between the productivity application 202 and the productivity service 204. A low number of intermediary connections may provide a low latency connection between the productivity application 202 and the productivity service 204. The low latency connection may establish the real time connection. For example, the real time connection may complete a transmission of the content change 215 under 10 milliseconds, 100 milliseconds, and/or 1 second, among others.

After receiving the content change 215 from the productivity application 202, the productivity service 204 may apply the content change 215 to the document 212. The content change 215 may include a text 220, a paragraph 230, and/or a format attribute 240, among others. The format attribute 240 may include a format change to be applied to a component of the document 212 such as a color change, and/or a font change, among others.

For example, a keystroke may be registered by the productivity application 202 as a content change 215 that adds a text 220 to the instance 210 of the document 212. The keystroke may be transmitted to the productivity service 204 in real time through the content channel 209. The productivity service may receive and apply the keystroke as the content change 215 into a location within the document 212 as detected on the instance 210.

The content change 215 may subsequently be transmitted (by the productivity service 204) through a content channel 208 in real time to the productivity application 206. For example, after applying a paragraph 230 as the content change 215 to the document 212, the productivity service may transmit the paragraph 230 as the content change 215 in real time through the content channel 208. The paragraph 230 may be transmitted to prompt the productivity application 206 to present the document 212 with the paragraph 230 within the instance 214. As a result, the paragraph 230 applied to the instance 210 of the document 212 may be displayed in real time within the instance 214 of the document 212.

The content change 215 may also include the format attribute 240. The format attribute 240 may include a font style, a font size, a background color, a foreground color, or a line size, among others applied to the document 212. The format attribute 240 may be transmitted as the content change 215 in real time through the content channel 209 to the productivity service 204. The productivity service 204 may apply the format attribute 240 to the document 212.

The productivity service 204 may transmit the format attribute 240 as the content change 215 through the content channel 209 to the productivity application to prompt the productivity application to present the document 212 with the format attribute 240. The format attribute 240 may be transmitted through the content channel 209 in real time to synchronize the content change 215 displayed on the document 212 between the productivity application 202 and the productivity application 206 in real time.

Examples are not provided herein in a limiting sense. More than two productivity applications may be used to collaborate in co-authoring of the document 212. In addition, a subsequent content change by the productivity application 206 may be transmitted through the content channel 208 and the content channel 209 to initiate a synchronization to present the subsequent content change between the other instance 214 and the instance 210 of the document 212.

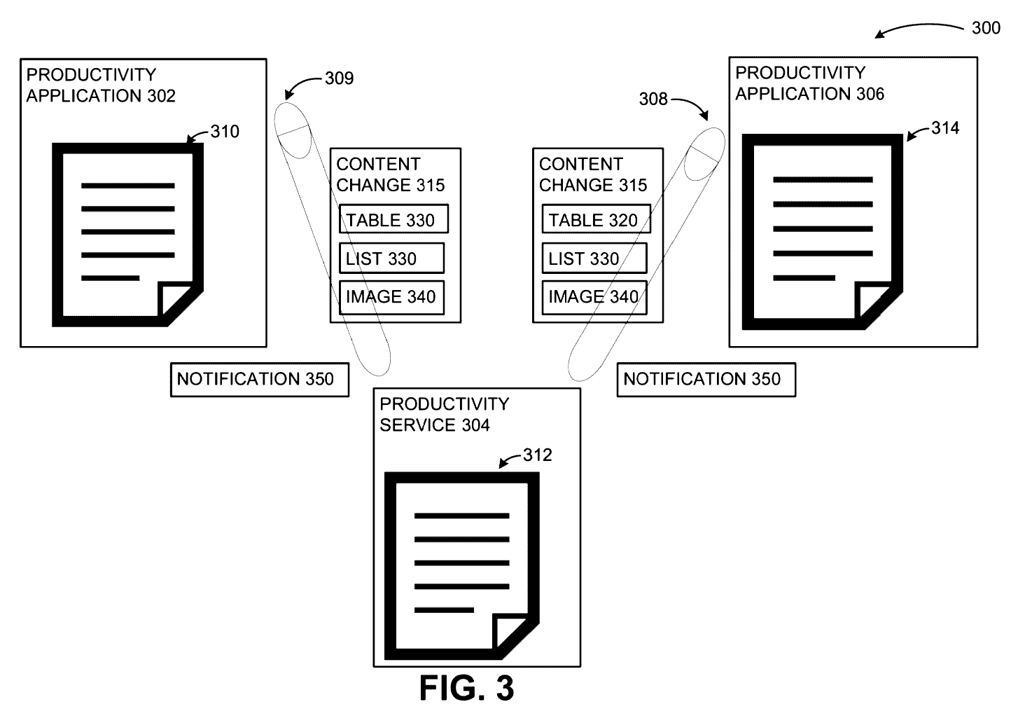

FIG. 3 is a diagram illustrating another example of an insertion of unsaved content into a document through a content channel, according to embodiments.

In a diagram 300, a productivity service 304 may receive a content change 315 detected in an instance of the document 312 transmitted through a content channel 309 in real time. The content change 315 may be applied to the document 312 and transmitted through a content channel 308 in real time to prompt a productivity application 306 to present the document 312 with the content change 315.

The content change 315 may include an insertion operation, an edit operation, and/or a deletion operation, among other operations associated with a table 320, a list 330, an image 340, an attachment (e.g.: a file), a component of the table 320 (e.g.: a cell, a row, or a column, among others), and/or a component of the list 330 (e.g.: a line, among others) applied to the document 312, among others. Real-time communication established through the content channel 309 and the content channel 308 may depend on a size of the content change 315 and network resources available to the content channels (308 and 309).

For example, the content change 315 may comprise inserting an image 340 having a size that is in an order of megabytes. The size may affect the period of time to complete a transmission from the productivity application 302 to the productivity service 304 based on an availability of network resources such as a network bandwidth of the content channel 309. A transmission of the image 340 to the productivity service 304 may be considered in real time if the transmission may be within a time period under 10 milliseconds, 100 milliseconds, 1 second, or another substantially real time interval.

A transmission of a content change 315 that has a larger size, such as in an order of megabytes, may also be in real time if the transmission is completed under a real time period threshold. For example, a transmission of the image 340 under a one second time period to the productivity service 304 through the content channel 309 may be considered within real time. The transmission of the image 340 may be considered in real time if a subsequent content change with a large size (e.g., another image or an attachment) is also applied to the document 312 after the transmission of the image 340.

A transmission of a content change 315 that has a smaller size, such as in an order of bytes or kilobytes, may be in real time because of a low latency connection and available network bandwidth of the content channel 309. For example, component content change 315 such as an edit made to a row, a column, or a cell of a table 320 may be transmitted within a time period under 10 milliseconds or 100 milliseconds to the productivity service 304 through the content channel 309. The time period under 10 milliseconds or 100 milliseconds, or another substantially real time interval, may be considered as real time.

The content change 315 (that may include the table 320, the list 330, and/or the image 340, among others) may be received by the productivity service 304 to apply to the document 312 through the content channel 309. Subsequently, the productivity service 304 may transmit the content change 315 to the productivity application 306 through the content channel 308 in real time to prompt the productivity application 306 to present the document 312 with the change within the other instance 314. As a result, the content change 315 may be applied to the document 312 in real time and displayed within the other instance 314 in real time.

Conflicts between the instance 310 and the other instance 314 may be detected and resolved through save operations. For example, a change applied to a section of the document 312 displayed on the instance 310 may be detected as in conflict with another change applied to the same section of the document 312 displayed on the instance 314.

A save operation may be initiated by the productivity application 302 through a manual save operation or an automated save operation such as a recurring event, and/or a threshold based event, among others. The save operation may also be initiated by the productivity service 304 through an automated save operation such as a recurring event, and/or a threshold based event, among others. The threshold based event may include available of resources exceeding a threshold. For example, when available I/O resources exceed a successful write threshold, a write event may be successfully executed to store the document 312.

In response to receiving instructions (from the productivity application 302) to save the document 312, the productivity service 304 may retrieve the instance 310 from the productivity application 302 and the other instance 314 from the productivity application 306. The instance 310 may be transmitted through a save operation channel (not displayed) that may be separate from the content channel 309. The other instance 314 may be transmitted through a save operation channel (not displayed) that may be separate from the content channel 308.

The instance 310 and the other instance 314 may be compared to detect out-of-sync content changes between the instance 310 and the other instance 314. In response to a failure to detect the out-of-sync content changes, the instance 310 may be saved into the document 312. A notification 350 may be transmitted to the productivity applications (302 and 306) to prompt the productivity applications (302 and 306) to display the notification 350 that describes a success of the save operation. Changes between the instance 310 and pre-saved version of the document 312 may also be summarized with the notification 350.

In response to a detection of the out-of-sync content changes, the productivity service 304 may reject the save operation. The productivity service 304 may transmit a notification 350 to the productivity applications (302 and 306) to prompt the productivity applications (302 and 306) to display the notification 350 that includes a description of the failure to save the instance 310. The notification 350 may also include a summary of the out-of-sync content changes between the document 312, the instance 310, and/or the instance 314.

Alternatively, in response to a detection of the out-of-sync content changes, the productivity service 304 may execute conflict resolution rules to resolve the conflicts associated with the out-of-sync content changes. Examples of conflict resolution rules may include evaluation of roles associated with an editor of the instance 310 and the editor of the instance 314. If the editor of the instance 310 has higher level permissions to the document 312 compared to permissions of the editor of the instance 314 then content changes associated with the editor of the instance 310 may be saved. The content changes associated with the editor of the instance 314 may be discarded. Examples of conflict resolution rules are not provided herein in a limiting sense; other conflict resolution rules may be applied to resolve out-of-sync content changes between the instance 310 and the instance 314 of the document 312.

In response to a successful operation to resolve the conflicts, the instance 310 may be saved into the document 312. A notification 350 that describes a successful operation to save the instance 310 and also describes the resolved conflicts may also be transmitted to the productivity applications (302 and 306). The notification 350 may be transmitted to prompt the productivity applications (302 and 306) to display the notification 350.

In response to a failure to resolve the conflicts, a notification 350 that describes a failure to resolve the conflicts and a failure to save the instance 310 as the document 312 may be transmitted to the productivity applications (302 and 306). The notification 350 may be transmitted to prompt the productivity applications (302 and 306) to display the notification 350. The notification 350 may be transmitted through the content channels (308 and 309).

Examples of the save operation are provided herein that save content changes in the instance 310 to the document 312. The example save operation is not provided in a limiting sense. Alternatively, a save operation initiated by the productivity application 306 (or the productivity service 304) may save the content changes in the instance 314 to the document 312, in addition or alternatively to other suitable save operations.

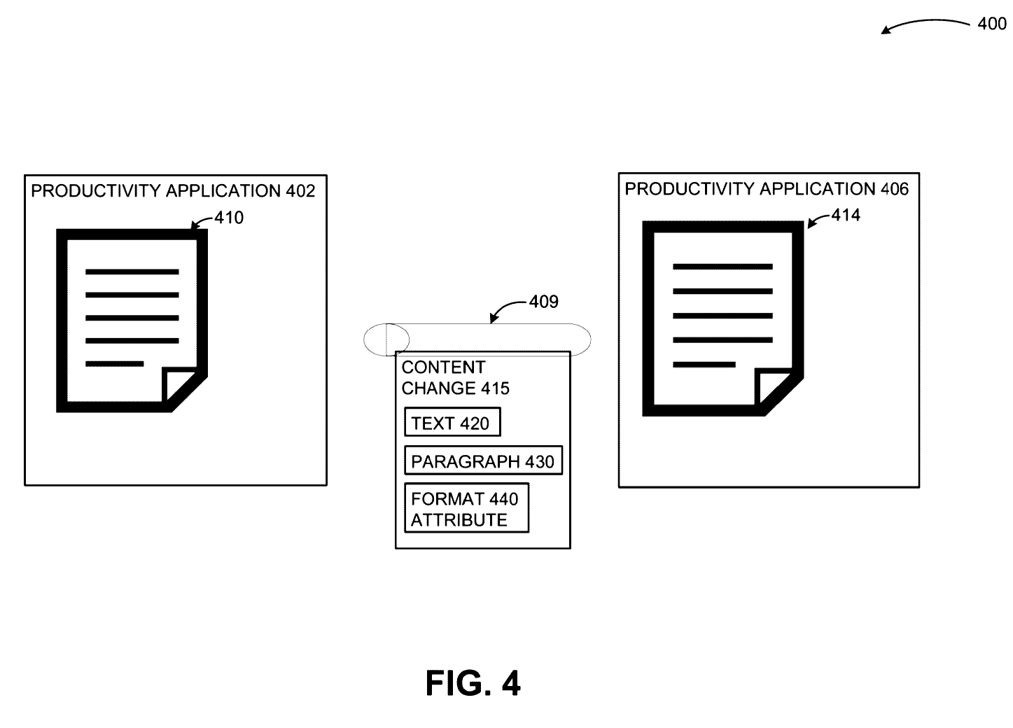

FIG. 4 is a diagram illustrating an example scenario of an insertion of unsaved content into a document through a content channel that provides a peer-to-peer service, according to embodiments.

In a diagram 400, a productivity application 402 may transmit a content change 415 of a document 410 to a productivity application 406 through a content channel 409 in real time. The content change 415 may be transmitted for application into an instance 414 of the document 410. The instance 414 may include a copy of the document 410 that is synchronized to the document 410. Alternatively, the instance 414 may include a section of the document 410 (such as a paragraph and/or a page) that is displayed by the productivity application 406.

The content change 415 may include a text 420, a paragraph 430, and/or a format attribute 440, among others, which may be transmitted through the content channel 409 for presentation in the document 410 through the instance 414.

The productivity application 402 may establish the content channel 409 with the productivity application 406 to transmit the content change 415 in real time. The real time communications may be established by constructing the content channel 409 with a low latency connection with a scheme to connect through a least number of intermediary connections through other nodes in a network. Transmission of the content change 415 through the content channel 409 may allow real time presentation of the content change 415 through the instance 414.

Conflicts between the document 410 and the instance 414 may be resolved during a save operation initiated by either the productivity application 402 and/or the productivity application 406. Conflict rules may be executed to attempt to resolve out-of-sync content changes. Alternatively, a save operation may be rejected because of the out-of-sync content changes. Notifications about resolutions to the conflicts or a rejection of the save operation may be transmitted between the productivity applications (402 and 406). The notifications may be transmitted through the content channel 409.

Additionally, context information (not displayed) associated with the content change 415 may be transmitted from the productivity application 402 to the productivity application 406 to prompt the productivity application 406 to display the context information. The context information may include a state of an edit operation, an insertion operation, and/or a deletion operation, among other operations associated with the content change 415. For example, context information that describes a typing state of the text 420 may be transmitted through the content channel 409. The context information may be transmitted to prompt the productivity application 406 to display the context information to inform an editor of the document 412 of an upcoming content change.

As discussed above, the application may be employed to perform operations associated with insertion of unsaved content through a content channel. Among other benefits, an increased user efficiency with the productivity service 105 and/or the productivity applications (402 and 406) may occur as a result of transmitting a content change through a content channel to synchronize instances of a document in real time, as described herein. Additionally, by transmitting unsaved content through a separate content channel, resolving conflicts, and other operations, the productivity service 105 may reduce processor load, increase processing speed, conserve memory, and/or reduce network bandwidth usage.

Embodiments, as described herein, address a need that arises from a lack of efficiency between the users (106 and 107) interacting with the productivity applications (108 and 109) of the computing devices (102 and 103) while collaborating to co-author a document. The actions/operations described herein are not a mere use of a computer, but address results of a system that are direct consequences of software used as a service offered in conjunction with large numbers of users and applications.

The example scenarios and schemas in FIG. 1 through 4 are shown with specific components, data types, and configurations. Embodiments are not limited to systems according to these example configurations. Insertion of unsaved content through a content channel may be implemented in configurations employing fewer or additional components in applications and user interfaces. Furthermore, the example schema and components shown in FIG. 1 through 4 and their subcomponents may be implemented in a similar manner with other values using the principles described herein.

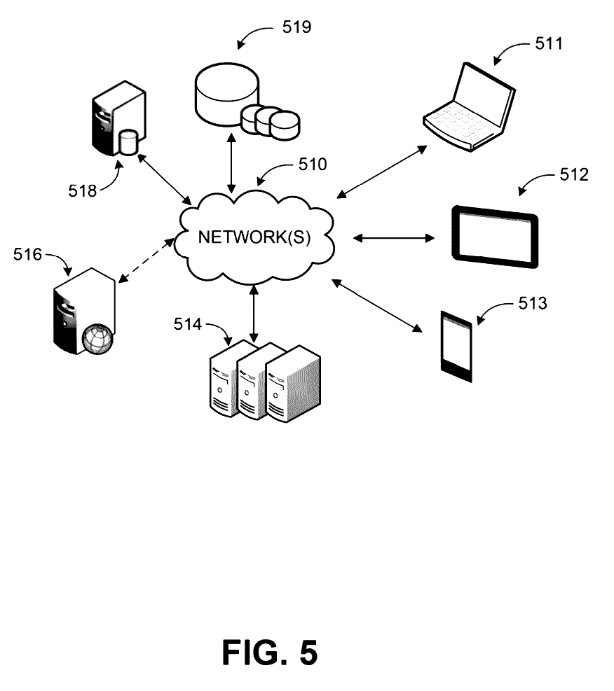

FIG. 5 is an example networked environment, where embodiments may be implemented. A productivity service configured to insert unsaved content through a content channel may be implemented via software executed over one or more servers 514 such as a hosted service. The platform may communicate with client applications on individual computing devices such as a smart phone 513, a mobile computer 512, or desktop computer 511 (‘client devices’) through network(s) 510.

Client applications executed on any of the client devices 511-513 may facilitate communications via application(s) executed by servers 514, or on individual server 516. A productivity service may receive a content change of a document from a productivity application through a content channel within a period of time. The period of time may be within a range of a real time. The content change may be applied to the document. The content change may be transmitted to another productivity application through another content channel within another period of time. The content change may be transmitted to prompt the other productivity application to present the document with the content change. The other period of time may also be within the range of the real time. The productivity service may store data associated with the principal document in data store(s) 519 directly or through database server 518.

Network(s) 510 may comprise any topology of servers, clients, Internet service providers, and communication media. A system according to embodiments may have a static or dynamic topology. Network(s) 510 may include secure networks such as an enterprise network, an unsecure network such as a wireless open network, or the Internet. Network(s) 510 may also coordinate communication over other networks such as Public Switched Telephone Network (PSTN) or cellular networks. Furthermore, network(s) 510 may include short range wireless networks such as Bluetooth or similar ones. Network(s) 510 provide communication between the nodes described herein. By way of example, and not limitation, network(s) 510 may include wireless media such as acoustic, RF, infrared and other wireless media.

Many other configurations of computing devices, applications, data sources, and data distribution systems may be employed to insert unsaved content through a content channel. Furthermore, the networked environments discussed in FIG. 5 are for illustration purposes only. Embodiments are not limited to the example applications, modules, or processes.

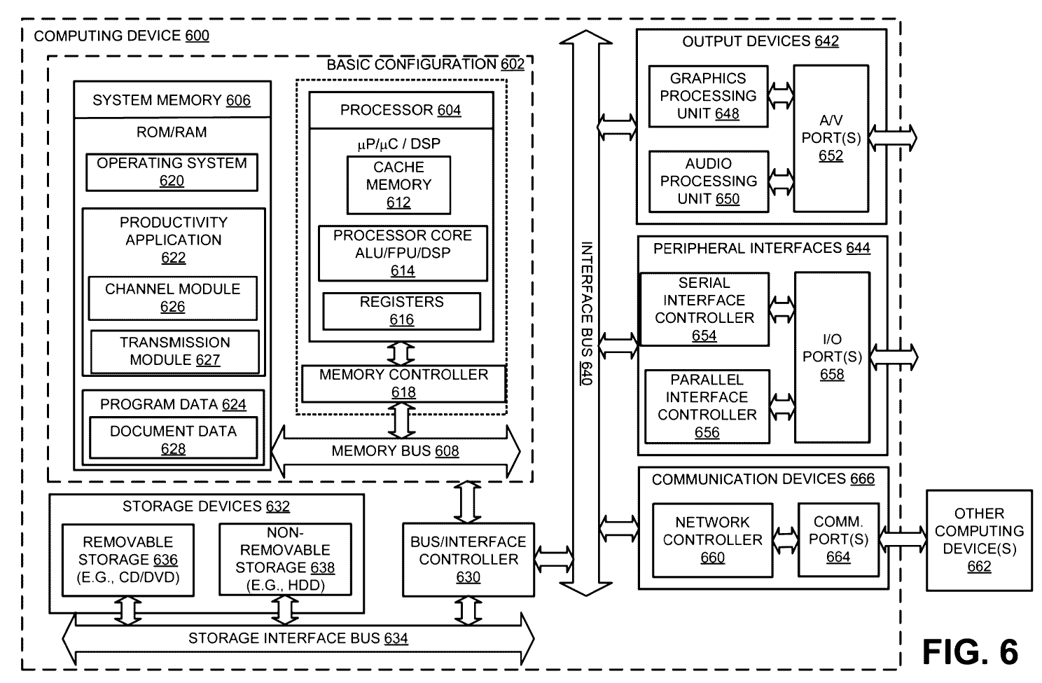

FIG. 6 is a block diagram of an example computing device, which may be used to insert unsaved content through a content channel.

For example, computing device 600 may be used as a physical server, desktop computer, portable computer, smart phone, special purpose computer, or similar device. In an example basic configuration 602, the computing device 600 may include one or more processors 604 and a system memory 606. A memory bus 608 may be used for communication between the processor 604 and the system memory 606. The basic configuration 602 may be illustrated in FIG. 6 by those components within the inner dashed line.

Depending on the desired configuration, the processor 604 may be of any type, including but not limited to a microprocessor (μP), a microcontroller (μC), a digital signal processor (DSP), or any combination thereof. The processor 604 may include one more levels of caching, such as a level cache memory 612, one or more processor cores 614, and registers 616. The example processor cores 614 may (each) include an arithmetic logic unit (ALU), a floating point unit (FPU), a digital signal processing core (DSP Core), or any combination thereof. An example memory controller 618 may also be used with the processor 604, or in some implementations, the memory controller 618 may be an internal part of the processor 604.

Depending on the desired configuration, the system memory 606 may be of any type including but not limited to volatile memory (such as RAM), non-volatile memory (such as ROM, flash memory, etc.), or any combination thereof. The system memory 606 may include an operating system 620, a productivity service 622, and a program data 624. The productivity service 622 may include a component such as a channel module 626 and a transmission module 627. The channel module 626 and the transmission module 627 may execute the processes associated with the productivity service 622. The channel module 626 may receive a content change of a document from a productivity application through a content channel within a period of time. The period of time may be within a range of a real time. The content change may be applied to the document. The transmission module 627 may transmit the content change to another productivity application through another content channel within another period of time. The content change may be transmitted to prompt the other productivity application to present the document with the content change. The other period of time may also be within the range of the real time

The productivity service 622 may receive and transmit content changes through a networking device associated with the computing device 600. An example of the networking device may include a hardware networking card that communicatively couples the computing device 600 with a network. The program data 624 may also include, among other data, document data 628, or the like, as described herein. The document data 628 may include a content change, and the document, among others.

The computing device 600 may have additional features or functionality, and additional interfaces to facilitate communications between the basic configuration 602 and any desired devices and interfaces. For example, a bus/interface controller 630 may be used to facilitate communications between the basic configuration 602 and one or more data storage devices 632 via a storage interface bus 634. The data storage devices 632 may be one or more removable storage devices 636, one or more non-removable storage devices 638, or a combination thereof. Examples of the removable storage and the non-removable storage devices may include magnetic disk devices, such as flexible disk drives and hard-disk drives (HDD), optical disk drives such as compact disk (CD) drives or digital versatile disk (DVD) drives, solid state drives (SSD), and tape drives, to name a few. Example computer storage media may include volatile and nonvolatile, removable, and non-removable media implemented in any method or technology for storage of information, such as computer-readable instructions, data structures, program modules, or other data.

The system memory 606, the removable storage devices 636 and the non-removable storage devices 638 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 600. Any such computer storage media may be part of the computing device 600.

The computing device 600 may also include an interface bus 640 for facilitating communication from various interface devices (for example, one or more output devices 642, one or more peripheral interfaces 644, and one or more communication devices 646) to the basic configuration 602 via the bus/interface controller 630. Some of the example output devices 642 include a graphics processing unit 648 and an audio processing unit 650, which may be configured to communicate to various external devices such as a display or speakers via one or more A/V ports 652. One or more example peripheral interfaces 644 may include a serial interface controller 654 or a parallel interface controller 656, which may be configured to communicate with external devices such as input devices (for example, keyboard, mouse, pen, voice input device, touch input device, etc.) or other peripheral devices (for example, printer, scanner, etc.) via one or more I/O ports 658. An example communication device 666 includes a network controller 660, which may be arranged to facilitate communications with one or more other computing devices 662 over a network communication link via one or more communication ports 664. The one or more other computing devices 662 may include servers, computing devices, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 600 may be implemented as a part of a general purpose or specialized server, mainframe, or similar computer, which includes any of the above functions. The computing device 600 may also be implemented as a personal computer including both laptop computer and non-laptop computer configurations.

Example embodiments may also include methods to insert unsaved content through a content channel. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

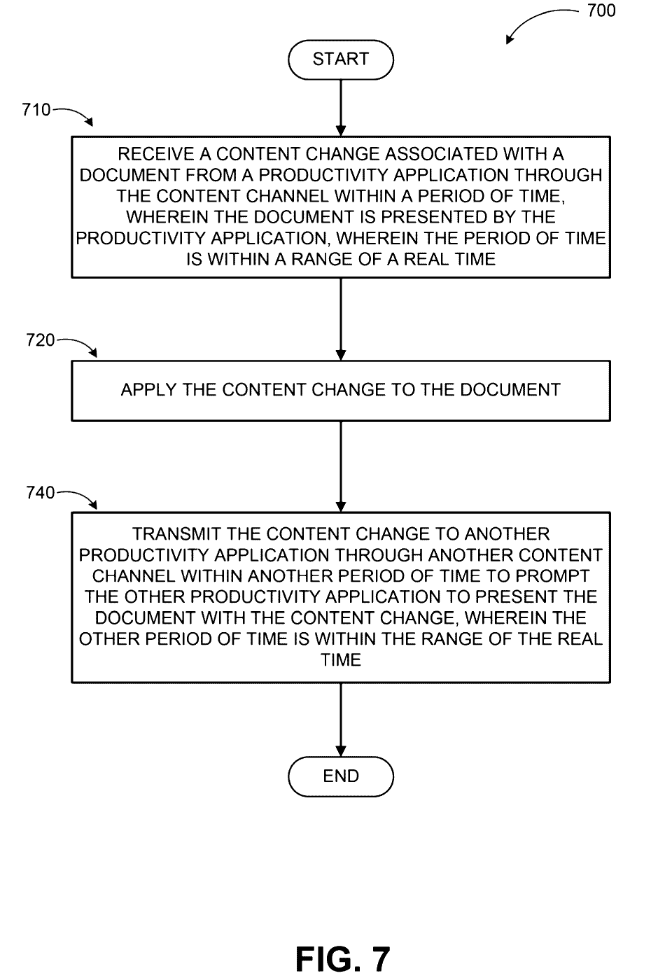

FIG. 7 is a logic flow diagram illustrating a process for an insertion of unsaved content through a content channel, according to embodiments. Process 700 may be implemented on a computing device such as the computing device 600 or other system.

Process 700 begins with operation 710, where a content change associated with a document may be received from a productivity application through a content channel within a period of time. The period of time may be within a range of a real time. At operation 720, the content change may be applied to the document. The content change may be applied in a location in the document that matches the location of the content change detected within an instance of the document presented by the productivity application.

At operation 730, the content change may be transmitted to another productivity application through another content channel within another period of time. The content change may be transmitted to prompt the other productivity application to present the document with the content change. The other period of time may be within the range of the real time.

The operations included in process 700 are for illustration purposes. Insertion of unsaved content through a content channel may be implemented by similar processes with fewer or additional steps, as well as in different order of operations using the principles described herein.

According to some examples, a means for inserting unsaved content through a content channel may be described. The means may include means for receiving a content change associated with a document from a productivity application through the content channel within a first period of time, where the document is presented by the productivity application, where the first period of time is within a range of a real time, means for applying the content change to the document, and means for transmitting the content change to another productivity application through another content channel within a second period of time to prompt the other productivity application to present the document with the content change, where the second period of time is within the range of the real time.

According to some examples, a server for inserting unsaved content through a content channel may be described. The server may include a networking device, a memory configured to store instructions associated with a productivity service. One or more processors coupled to the memory and the networking device, the one or more processors executing the productivity service in conjunction with the instructions stored in the memory. The productivity service includes a channel module configured to receive, by the networking device, a content change associated with a document from a productivity application through the content channel within a period of time, where the document is presented by the productivity application, where the period of time is within a range of a real time and apply the content change to the document. The productivity service further includes a transmission module configured to transmit, by the networking device, the content change to another productivity application through another content channel within another period of time to prompt the other productivity application to present the document with the content change, where the other period of time is within the range of the real time.

According to other examples, the content change includes one or more of: an insertion operation, an edit operation, and a delete operation of one or more of: a text, a paragraph, and a format attribute applied to the document. The content change includes one or more of: an insertion operation, an edit operation, and a delete operation of one or more of: a table, a list, an image, and an attachment applied to the document. The range of the real time includes a time period under one of: 10 milliseconds, 100 milliseconds, and 1 second.

According to further examples, the channel module is further configured to receive, by the networking device, a save instruction from the productivity application to save the document, retrieve, by the networking device, the document presented by the productivity application, retrieve, by the networking device, the document presented by the other productivity application, and compare the document presented by the productivity application and the document presented by the other productivity application to detect one or more out-of-sync content changes. In response to a detection of the one or more out-of-sync content changes, the save instruction is rejected.

The transmission module is further configured to transmit, by the networking device, a notification to the productivity application to prompt the productivity application to display the notification, where the notification describes a failure to save the document as a result of the one or more out-of-sync content changes, where the notification describes the one or more out-of-sync content changes.

According to other examples, the channel module is further configured to in response to a failure to detect the one or more out-of-sync content changes, save the document and the transmission module is further configured to transmit, by the networking device, a notification to the productivity application and the other productivity application to prompt the productivity application and the other productivity application to display the notification, where the notification describes a successful operation to save the document.

According to further examples, the channel module is further configured to initiate an automated save operation, where the automated save operation is based on one or more of: a recurring event and a threshold event, retrieve the document presented by the productivity application, retrieve the document presented by the other productivity application, compare the document presented by the productivity application and the document presented by the other productivity application to detect one or more out-of-sync content changes, and in response to a failure to detect the one or more out-of-sync content changes, save the document.

According to other examples, the channel module is further configured to initiate an automated save operation, where the automated save operation is based on one or more of: a recurring event and a threshold event, retrieve the document presented by the productivity application, retrieve the document presented by the other productivity application, compare the document presented by the productivity application and the document presented by the other productivity application to detect one or more out-of-sync content changes, in response to a detection of the one or more out-of-sync content changes, attempt to resolve one or more conflicts associated with the one or more out-of-sync content changes based on one or more conflict resolution rules, and in response to a successful operation to resolve the one or more conflicts associated with the one or more out-of-sync content changes, save the document.

According to further examples, the transmission module is further configured to transmit, by the networking device, a notification to the productivity application and the other productivity application to prompt the productivity application and the other productivity application to display the notification, where the notification describes a successful operation to save the document, where the notification describes one or more resolutions to the one or conflicts associated with the out-of-sync content changes.

According to some examples, a method for an insertion of unsaved content through a content channel may be described. The method may include receiving a content change associated with a document from a productivity application through the content channel within a first period of time, where the document is presented by the productivity application, where the first period of time is within a range of a real time, applying the content change to the document, and transmitting the content change to another productivity application through another content channel within a second period of time to prompt the other productivity application to present the document with the content change, where the second period of time is within the range of the real time.

The method may further include receiving another content change associated with the document from the other productivity application through the other content channel within a third period of time, where the third period of time is within the range of the real time, applying the other content change to the document, transmitting the other content change to the productivity application through the content channel within a fourth period of time to prompt the productivity application to present the document with the other content change, where the fourth period of time is within the range of the real time, and transmitting a notification to the productivity application and the other productivity application to prompt the productivity application and the other productivity application to display the notification, where the notification describes a success to synchronize the other content change with the document.

The method may further include receiving context information associated with another content change associated with document from the productivity application, where the context information is received through the content channel and transmitting the context information associated with the other content change through the other content channel to the other productivity application to prompt the other productivity application to display the context information where the context information includes a description of a state of one or more of: an edit operation, an insertion operation, and a deletion operation associated with the other content change.

According to some examples, a computer-readable memory device with instructions stored thereon for an insertion of unsaved content through a content channel may be described. The instructions may include detecting a content change associated with a document, where the content change includes one or more of: an insertion operation, an edit operation, and a delete operation of one or more of: a text, a paragraph, a format attribute, a table, a list, an image, and an attachment applied to the document, applying the content change to the document, and transmitting the content change to a document productivity application through a content channel within a period of time to prompt the productivity application to present the document with the content change, where the time period is within a range of real time.

According to other examples, the instructions may further include initiating an automated save operation to save the document, where the automated save operation is based on one or more of: a recurring event and a threshold event, retrieving the document presented by the productivity application, identifying one or more out-of-sync changes in the document presented by the productivity application, and cancelling the automated save operation.

According to other examples, the instructions may further include identifying context information associated with another content change associated with the document, where the context information includes a description of a state of one or more of: an edit operation, an insertion operation, and a deletion operation associated with the other content change and transmitting the context information associated with the content change through the content channel to the productivity application to prompt the productivity application to display the context information.

According to some examples, a means to insert unsaved content through a content channel may be described. The means to insert unsaved content through a content channel may include a means to receive a content change associated with a document from a productivity application through the content channel within a period of time, where the document is presented by the productivity application, where the period of time is within a range of a real time, a means to apply the content change to the document, a means to transmit the content change to another productivity application through another content channel within another period of time to prompt the other productivity application to present the document with the content change, where the other period of time is within the range of the real time.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A server for inserting unsaved content through a content channel, the server comprising:
a networking device;
a memory configured to store instructions associated with a productivity service;
one or more processors coupled to the memory and the networking device, the one or more processors executing the productivity service in conjunction with the instructions stored in the memory, wherein the productivity service includes:
a channel module configured to:
receive, by the networking device, a content change associated with a document from a productivity application through the content channel within a period of time, wherein the document is presented by the productivity application, wherein the period of time is within a range of a real time;
apply the content change to the document; and
a transmission module configured to:
transmit, by the networking device, the content change to another productivity application through another content channel within another period of time to prompt the other productivity application to present the document with the content change, wherein the other period of time is within the range of the real time.

2. The server of claim 1, wherein the content change includes one or more of an insertion operation, an edit operation, and a delete operation of one or more of: a text, a paragraph, and a format attribute applied to the document.

3. The server of claim 1, wherein the content change includes one or more of: an insertion operation, an edit operation, and a delete operation of one or more of: a table, a list, an image, and an attachment applied to the document.

4. The server of claim 1, wherein the range of the real time includes a time period under one of 10 milliseconds, 100 milliseconds, and 1 second.

5. The server of claim 1, wherein the channel module is further configured to:
receive, by the networking device, a save instruction from the productivity application to save the document;
retrieve, by the networking device, the document presented by the productivity application;
retrieve, by the networking device, the document presented by the other productivity application; and
compare the document presented by the productivity application and the document presented by the other productivity application to detect one or more out-of-sync content changes.

6. The server of claim 5, wherein the channel module is further configured to:
in response to a detection of the one or more out-of-sync content changes, reject the save instruction.

7. The server of claim 6, wherein the transmission module is further configured to:
transmit, by the networking device, a notification to the productivity application to prompt the productivity application to display the notification, wherein the notification describes a failure to save the document as a result of the one or more out-of-sync content changes, wherein the notification describes the one or more out-of-sync content changes.

8. The server of claim 5, wherein the channel module is further configured to:
in response to a failure to detect the one or more out-of-sync content changes, save the document.

9. The server of claim 8, wherein the transmission module is further configured to:
transmit, by the networking device, a notification to the productivity application and the other productivity application to prompt the productivity application and the other productivity application to display the notification, wherein the notification describes a successful operation to save the document.

10. The server of claim 1, wherein the channel module is further configured to:
initiate an automated save operation, wherein the automated save operation is based on one or more of: a recurring event and a threshold event;
retrieve the document presented by the productivity application;
retrieve the document presented by the other productivity application;
compare the document presented by the productivity application and the document presented by the other productivity application to detect one or more out-of-sync content changes; and
in response to a failure to detect the one or more out-of-sync content changes, save the document.

11. The server of claim 1, wherein the channel module is further configured to:
initiate an automated save operation, wherein the automated save operation is based on one or more of: a recurring event and a threshold event;
retrieve the document presented by the productivity application;
retrieve the document presented by the other productivity application;
compare the document presented by the productivity application and the document presented by the other productivity application to detect one or more out-of-sync content changes;
in response to a detection of the one or more out-of-sync content changes, attempt to resolve one or more conflicts associated with the one or more out-of-sync content changes based on one or more conflict resolution rules; and
in response to a successful operation to resolve the one or more conflicts associated with the one or more out-of-sync content changes, save the document.

12. The server of claim 11, wherein the transmission module is further configured to:
transmit, by the networking device, a notification to the productivity application and the other productivity application to prompt the productivity application and the other productivity application to display the notification, wherein the notification describes a successful operation to save the document, wherein the notification describes one or more resolutions to the one or conflicts associated with the out-of-sync content changes.

13. A method executed on a computing device for an insertion of unsaved content through a content channel, the method comprising:
receiving a content change associated with a document from a productivity application through the content channel within a first period of time, wherein the document is presented by the productivity application, wherein the first period of time is within a range of a real time;
applying the content change to the document; and
transmitting the content change to another productivity application through another content channel within a second period of time to prompt the other productivity application to present the document with the content change, wherein the second period of time is within the range of the real time.

14. The method of claim 13, further comprising:
receiving another content change associated with the document from the other productivity application through the other content channel within a third period of time, wherein the third period of time is within the range of the real time; and
applying the other content change to the document.

15. The method of claim 14, further comprising:
transmitting the other content change to the productivity application through the content channel within a fourth period of time to prompt the productivity application to present the document with the other content change, wherein the fourth period of time is within the range of the real time; and
transmitting a notification to the productivity application and the other productivity application to prompt the productivity application and the other productivity application to display the notification, wherein the notification describes a success to synchronize the other content change with the document.

16. The method of claim 13, further comprising:
receiving context information associated with another content change associated with document from the productivity application, wherein the context information is received through the content channel; and
transmitting the context information associated with the other content change through the other content channel to the other productivity application to prompt the other productivity application to display the context information.

17. The method of claim 16, wherein the context information includes a description of a state of one or more of: an edit operation, an insertion operation, and a deletion operation associated with the other content change.

18. A computer-readable memory device with instructions stored thereon for an insertion of unsaved content through a content channel, the instructions comprising:
detecting a content change associated with a document, wherein the content change includes one or more of: an insertion operation, an edit operation, and a delete operation of one or more of: a text, a paragraph, a format attribute, a table, a list, an image, and an attachment applied to the document;
applying the content change to the document; and
transmitting the content change to a document productivity application through a content channel within a period of time to prompt the productivity application to present the document with the content change, wherein the time period is within a range of real time.

19. The computer-readable memory device of claim 18, wherein the instructions further comprise:
initiating an automated save operation to save the document, wherein the automated save operation is based on one or more of: a recurring event and a threshold event;
retrieving the document presented by the productivity application;
identifying one or more out-of-sync changes in the document presented by the productivity application; and
cancelling the automated save operation.

20. The computer-readable memory device of claim 18, wherein the instructions further comprise:
identifying context information associated with another content change associated with the document, wherein the context information includes a description of a state of one or more of: an edit operation, an insertion operation, and a deletion operation associated with the other content change; and
transmitting the context information associated with the content change through the content channel to the productivity application to prompt the productivity application to display the context information.
